(19) United States
(12) Patent Application Publication
(10) Pub. No.: US 2014/0129347 A1
(43) Pub. Date: May 8, 2014

(54) INTELLIGENT AND INFORMED ADVERTISEMENT CREATION

(71) Applicant: Anantha Pradeep, Piedmont, CA (US)

(72) Inventor: Anantha Pradeep, Piedmont, CA (US)

(21) Appl. No.: 14/023,323

(22) Filed: Sep. 10, 2013

Related U.S. Application Data
(60) Provisional application No. 61/722,358, filed on Nov. 5, 2012.

(51) Int. Cl. G06Q 30/02

(52) U.S. Cl. CPC G06Q 30/0269
USPC 705/14.66

(57) ABSTRACT

Mechanisms are provided for intelligently creating advertisements in a neurologically informed manner. A framework is provided for intelligently generating an advertisement and optimizing the advertisement for particular contexts including display characteristics, viewer emotions, and biorhythms. Multiple versions or variations of an advertisement may be manually or automatically generated to suit particular environmental and viewer characteristics. Advertisements can also be provided with wrappers to allow improved connectivity and flow with surrounding media.

### CROSS-REFERENCE TO RELATED APPLICATIONS

This application claims the benefit under 35 U.S.C. §119(e) of U.S. Provisional Patent Application 61/722,358, entitled: “INTELLIGENT AND INFORMED ADVERTISEMENT CREATION” filed on Nov. 5, 2012 (Attorney Docket No. PRDPP007P), which is incorporated herein by reference in its entirety.

### TECHNICAL FIELD

The present disclosure relates to intelligent and informed advertisement creation.

### DESCRIPTION OF RELATED ART

Conventional advertisement creation usually involves creative teams including copywriters and art directors that generate ideas for advertisement proposals after receiving requirements or creative briefs from clients or account executives. The ideas typically include a message promoting a particular client, product, or service. Creative teams make proposals, receive feedback, modify their ideas, and receive additional feedback from a variety of sources such as creative directors, account executives, the clients themselves, focus groups, etc. Creative teams have to be aware of not just client needs and desires, but they must also understand creativity, marketing, and the attitudes, behaviors, and other characteristics of members of the target audience.

After proposals are accepted, advertisements generated by creative teams are produced into actual media content. Advertisements may be generated in-house or through use of a variety of advertisement agencies including creative agencies, web content based agencies, search engine optimization firms, social media agencies, and healthcare and medical education agencies. Clients typically include businesses and corporations, non-profit organizations, and government agencies.

Advertisements may include television commercials, print advertisements, media segments, brochures, billboards, audio clips, banner advertisements, classifieds, etc. Although advertisement creation processes are effective in many instances, they are typically not neurologically informed. In many instances, advertisements are created and evaluated using focus groups and, in some instances, may even be neurologically evaluated after production. However, the advertisement creation process itself is conventionally not neurologically informed.

Consequently, techniques and mechanisms of the present invention provide improved mechanisms for generating and customizing advertisements.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates a particular example of a framework for generating an advertisement.

FIGS. 2A-2B illustrate a particular example of a mechanism for selecting advertisements for displays having particular characteristics.

FIG. 3 illustrates a particular example of a mechanism for presenting advertisements based on emotion.

FIG. 4 illustrates a particular example of a mechanism for biorhythm-based advertisement creation.

FIG. 5 illustrates a particular example of a server.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques and mechanisms of the present invention will be described in the context of particular types of advertisements. However, it should be noted that the techniques and mechanisms of the present invention apply to a variety of different types of advertisements. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Mechanisms are provided for intelligently creating advertisements in a neurologically informed manner. A framework is provided for intelligently generating an advertisement and optimizing the advertisement for particular contexts including display sizes/resolutions, viewer emotions, and biorhythms. Multiple versions or variations of an advertisement may be manually or automatically generated to suit particular environmental and viewer characteristics. Advertisements can also be provided with wrappers to allow improved connectivity and flow with surrounding media.

### Example Embodiments

Current techniques for enhancing advertising are limited. In many examples, creative teams receive creative briefs from clients or account liaisons that detail requirements, purpose, target audiences, audience member behavior, messages, and rationale behind the messages. In some examples, art directors and copywriters generate ideas based on the creative brief for submission as proposals. Proposals are submitted to various parties such as art directors, executives, clients, outside firms, etc., for review and revision. Advertisements are produced using the ideas and proposals and the advertisements may be further reviewed to elicit additional feedback. In some instances, the advertisements may be focus group evaluated or even neurologically evaluated. However, although the process can be effective in generating advertisements, the process can be inefficient and ineffective in many instances. Much time and effort can be spent generating advertisements based on good ideas that may have a limited or unintended impact on target audiences.

In some instances, late stage feedback may require that an entire advertisement generation process be restarted. Consequently, techniques and mechanisms of the present invention provide improved mechanisms for intelligently generating neurologically informed advertisements. These advertisements may be commercials, billboards, print advertisements, banner advertisements, audio segments, etc.

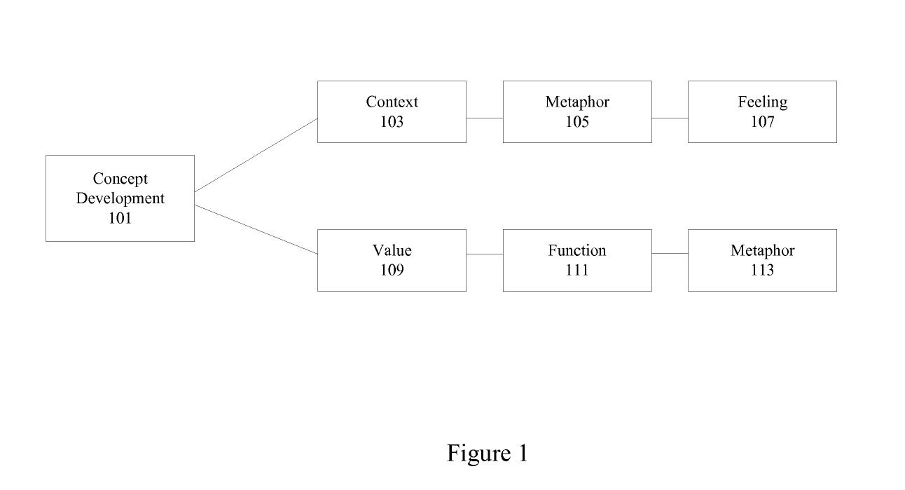

FIG. 1 illustrates a particular example of a framework for generating an advertisement. According to various embodiments, concept development 101 for an advertisement may be accomplished along two fundamental neuro-based pathways. One platform for concept development includes considering context 103, metaphor 105, and feeling 107. Another platform for concept development includes considering value 109, function 111, and metaphor 113. The techniques and mechanisms of the present invention recognize that advertisements generated using these platforms are neurologically effective.

According to various embodiments, the first platform involves creating an advertisement based on context, 103, metaphor 105, and feeling 107. The brain seeks context in all that it processes, so the selection of the setting for a scene in an advertisement is important for providing context 103. In addition, the brain interprets much of what it perceives using metaphors. Metaphors are messages about a brand that, while not literally true, can represent the ambition or aspiration of the brand, including its characteristics and associations. Accordingly, consideration of the particular ambitions or aspirations of a brand can be expressed through the use of metaphor 105 in an advertisement. In addition, the feeling 107 of a brand, which is the automatic emotional association that arises at the thought or mention of a brand, can be considered during concept development.

One example of an advertisement corresponding to the context-metaphor-feeling framework is a diapers advertisement where the context 103 is a nighttime scene featuring a mom who aspires to be the best possible mom. The mom watches her baby with love and uses a diaper that can be changed with ease at night without waking the baby. The advertisement may continue by showing a baby comfortably continuing to sleep. The metaphor 105 in this advertisement says the diaper is quiet, calming, soothing, and dependable. This metaphor can also suggest that by choosing this brand of diaper, the mom is a caring, responsible, and good mom. The feeling 107 invoked may be that of comfort, calmness, fondness, and sentimentality.

According to various embodiments, the second platform involves creating an advertisement based on value 109, function 111, and metaphor 113. According to this framework, value 109 refers to the social and moral values with which a brand is associated. Some examples of values that can be associated with a brand include: personal, spiritual, moral, communal, social, political, economic, philosophical, historical, traditional, cultural, national, environmental, legal, and/or lifecycle-related. Brands with particular social or moral value associations can resonate more with consumers who share the same social or moral values. Furthermore, these consumers may feel more strongly connected to the brand. In the present framework, function 111 refers to those functions of the brand that are indispensable and unique. In particular, indispensable characteristics of a brand refer to those characters that consumers consider to be indispensable at a deep subconscious level. Unique characteristics of a brand refer to those qualities that make a brand distinguishable from another brand in the category and that make a consumer less likely to switch to a substitute brand or product in the category. Next, metaphor 113 can be considered during concept development. Metaphors are messages about a brand that, while not literally true, can represent the ambition or aspiration of the brand, including its characteristics and associations. Accordingly, consideration of the particular ambitions or aspirations of a brand can be expressed through the use of metaphor 105 during development of an advertisement.

According to various embodiments, advertisements may be automatically analyzed during generation to identify conformance to the framework described above. Particular variations from the framework may be useful in particular instances, but these variations are automatically detected and identified. In some instances, a template for advertisements may be provided to allow insertion of particular products, services, metaphors, functions, etc. The templates may apply across services and industries.

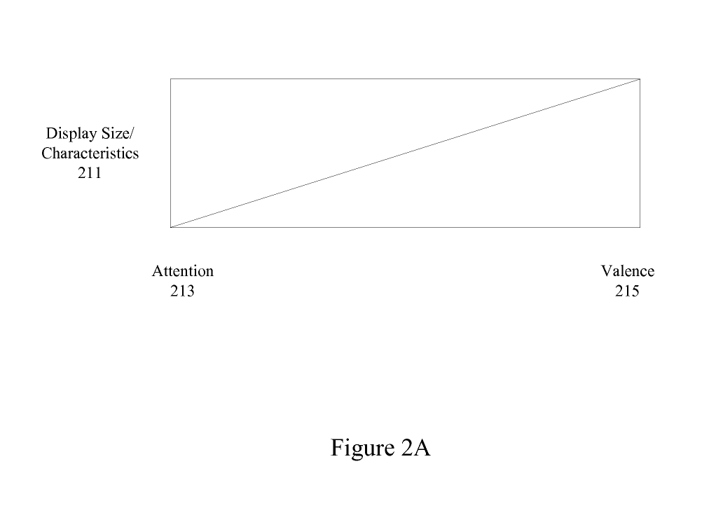

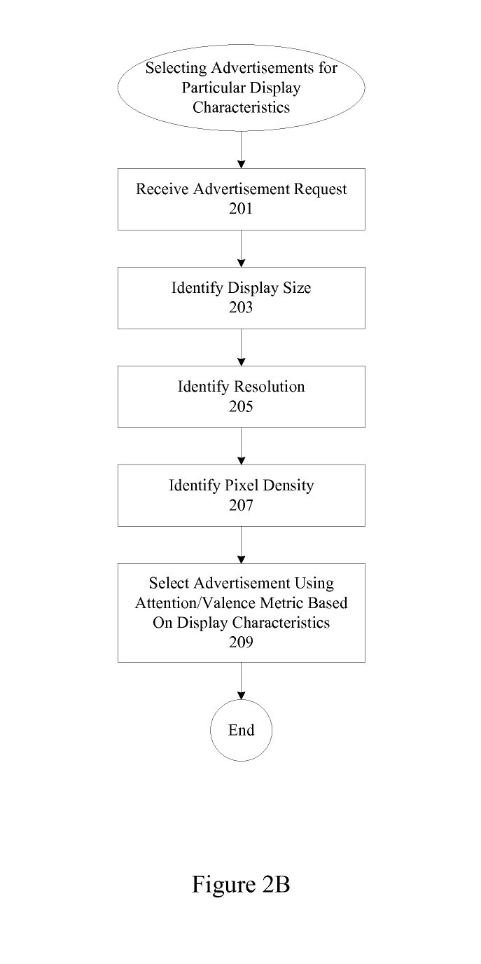

FIGS. 2A-2B illustrate a particular example of a mechanism for selecting advertisements to be displayed on screens having particular characteristics. According to various exemplary embodiments, multiple versions or variations of an advertisement can be generated to allow optimal advertisement placement, based on device screen size, resolution, and/or pixel density.

With reference to FIG. 2A, shown is a diagram illustrating the effectiveness of focusing on attention versus valence when selecting an advertisement for various display sizes and/or characteristics. In the present exemplary embodiment, display size/characteristics 211 refers to screen sizes, resolutions, and pixel densities of a display used to show an advertisement. Furthermore, in the present embodiment, attention 213 refers to getting the viewer's attention with an advertisement, while valence 215 refers to the emotional attractiveness or aversiveness of an advertisement. In other words, valence can be used to describe whether the content of the advertisement creates a pleasant or unpleasant experience.

Consumer subconscious responses in multi-screen environments are understood and analyzed to allow development of messaging content and executional techniques that maximize viewer awareness and receptivity. The techniques and mechanisms of the present invention recognize that attention 213 is the appropriate metric for smaller screen sizes and lower resolutions while emotional valence 215 is the appropriate metric for larger screen sizes and higher resolutions. Advertisements may be generated for particular screen sizes, resolutions, and pixel densities to optimize metrics based on display characteristics. In some instances, multiple versions of an advertisement are generated and a particular version is automatically selected based on display characteristics.

Various mechanisms can be employed to create attention-focused or valence-focused advertisements. In particular, high technology visual and audio effects can be used to enhance advertisement creation. The brain is “magnetically” attracted to certain stimuli, and optical illusions are one example. Audio techniques are also a neurologically-proven mechanism to draw attention, stimulate emotional engagement, and enhance memory retention. Using new advances in high technology, advertisement creation will leverage these capabilities to heighten the effectiveness of messaging and consumer experiences across multiple touchpoints, from advertising to events to in-store environments.

With either attention or valence as the focus of a particular advertisement, neuro-compression can be used according to various embodiments. Neuro-compression (i.e., shorten commercial but still include the neurologically relevant emotions, reactions) can be applied to produce neurologically impactful messages in short formats, which are the required ‘currency’ for critical marketing platforms including mobile communications and social media.

According to various embodiments, neuro-iconic signatures can also be used in creating advertisements, whether attention-based or valence-based. Neuro-iconic signatures are the specific moments during product consumption that generate the highest levels of brain engagement. This can be detected at moments when the person has a peak response in brain wave pattern. Neuro-iconic signatures can be extracted and embedded into messaging, design, and all other avenues where the inclusion of this powerful neurological phenomenon can be applied. In particular embodiments, neuro-iconic signatures may represent one of the core ‘connective tissues’ that link different executions across different channels to allow for maximum neurological coherence and marketplace effectiveness.

FIG. 2B illustrates a particular example of a mechanism for selecting advertisements for particular display characteristics. At 201, an advertisement request is received. For instance, a request can be received from a smart phone, billboard in a mall/airport, computer, tablet, notebook, electronic banner in an arena, etc. Once the request is received, the display size is identified at 203. Next, at 205, the resolution of the display is identified. At 207, the pixel density of the display is identified. Once the information about the display size and characteristics is gathered, an advertisement is selected using the attention/valence metric described above with regard to FIG. 2A. For example, if the display size is small, resolution is low, and pixel density is low, an advertisement can be selected that focuses primarily on getting a consumer's attention. Alternatively, in another example, if the display size is large, resolution is high, and pixel density is high, an advertisement can be selected that has a high valence, such that the content of the advertisement is appealing and pleasant to a consumer.

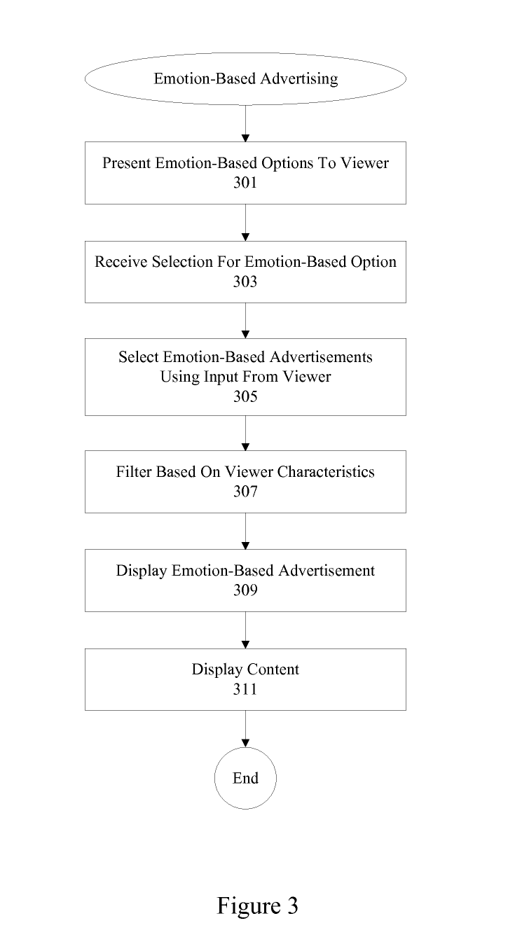

FIG. 3 illustrates a particular example of a mechanism for presenting advertisements based on emotion. According to various embodiments, multiple versions or variations of an advertisement may be generated based on emotion. Because the brain devotes substantial resources to process emotions and because it places high value on what it perceives to be particularly relevant data (such as personalized product and messaging), selecting an appropriate advertisement based on emotion can increase the effectiveness of the advertisement and the viewer's opinion of the associated brand. Accordingly, rather than having viewers select advertisements based on a product or brand, advertisements may be selected based on a particular feeling or emotion.

With reference to FIG. 3, a viewer can be presented with emotion-based options for an upcoming advertisement at 301. According to various embodiments, these options can include various categories such as surprise/novelty, fear/anger, edgy/sensual, and comedic/funny. In one example, the viewer may be presented with various options and elect to see a comedic advertisement or a sensual advertisement. Once the viewer selects an option, the selection is received at 303.

Based on the selection received, an emotion-based advertisement is selected based on the viewer's selection at 305. As described above, variations of advertisements appealing to different emotions can be available for this selection. In some examples, numerous versions of an advertisement can be based on a 5-variant emotional advertisement creation model. In particular, advertisement variants can be generated around surprise/novelty, fear/anger, nostalgia, edginess/sensuality, and comedy. In some embodiments, a particular brand can have variant advertisements associated with it, where the variant advertisements differ by their emotional contexts. By creating variant ads for the same brand, the brand can reach a broader audience more effectively. In other embodiments, different brands or products that may naturally invoke particular emotions and advertisements may fall into particular emotional categories. If only one variant of an advertisement is created, then the reach of the advertisement will be limited to the viewers who select the emotion associated with the advertisement. In the present embodiment, advertisements are selected corresponding to the viewer's emotion-based option selection. For example, if the viewer selects a comedic advertisement, advertisements are filtered such that comedic advertisements are available for display. These advertisements can correspond to various brands, etc.

In the present embodiment, the selection of advertisements based on emotional context is then filtered based on viewer characteristics at 307. In some embodiments, the viewer characteristics can be based on the content surrounding the advertisement. For example, the content may be a television show, and the show may feature vampires, and be categorized as a fantasy or supernatural drama. From this information and the viewer's emotional selection of comedic content, the available comedic advertisements might be filtered to include comedic advertisements featuring vampires or other supernatural characters.

In the present exemplary embodiment, advertisements can also be chosen to create a more seamless experience between the content surrounding the advertisement and the advertisement itself. In particular, media asset wrapper connectivity can be provided to allow creation of a modular plug-in for advertisements that allows advertisements to blend more naturally with surrounding content. In particular embodiments, audio of a program surrounding an advertisement will blend with the audio of the advertisement itself. In other examples, lighting of the program surrounding the advertisement will blend with the lighting of the advertisement itself. This wrapper can be used with a variety of modular plug-in compatible advertisements. Based on the available wrappers for advertisements in the chosen emotion-based category, appropriate advertisements can be filtered such that the chosen advertisements correspond to the surrounding content.

Although characteristics about a viewer can be based on content as described above, some alternate embodiments may also factor in characteristics about a viewer's overall viewing preferences and patterns. This information can be derived explicitly by the viewer's selections or inputs, or implicitly by gathering data about the type and frequency and amount of content that the viewer has viewed in the past. By filtering advertisements based on the viewer's characteristics, the effectiveness of an advertisement shown to the viewer can be increased.

Once the available advertisements have been filtered based on viewer characteristics and the viewer's selected emotion, an advertisement having corresponding emotional content can be presented to the user at 309. In some exemplary embodiments, media asset wrapper connectivity can be provided to allow creation of a modular plug-in for advertisements that allows advertisements to blend more naturally with surrounding content. In particular embodiments, audio of a program surrounding an advertisement will blend with the audio of the advertisement itself. In other examples, lighting of the program surrounding the advertisement will blend with the lighting of the advertisement itself. This wrapper can be used with a variety of modular plug-in compatible advertisements. This wrapper can be used to blend from the previous content to the advertisement, to blend from the advertisement to the following content, or both.

Once the advertisement is shown, then the surrounding content can be displayed at 311. In some examples, the surrounding content is a television show or a movie. In other examples, the surrounding content is an audio based show such as a radio station, etc. As described above, media asset wrapper connectivity can be used to blend the advertisement seamlessly into the surrounding content in some embodiments. Blending in this way can make the advertisement more appealing to the viewer and create a more pleasant experience.

According to various embodiments, the present invention identifies the central emotional contexts within which commercial messaging can perform, and increases the effectiveness of client advertising and other promotional materials presented to a viewer by providing a customized emotion-based experience.

In particular exemplary embodiments, neuro-compression can be used effectively in emotion-based advertisement. Neuro-compression (i.e., shorten commercial but still include the neurologically relevant emotions, reactions) can be applied to produce neurologically impactful messages in short formats, which are the required ‘currency’ for critical marketing platforms including mobile communications and social media.

In addition, neuro-iconic signatures can also be used in creating emotion-based advertisements, according to various embodiments. Neuro-iconic signatures are the specific moments during product consumption that generate the highest levels of brain engagement. This can be detected at moments when the person has a peak response in brain wave pattern. Neuro-iconic signatures can be extracted and embedded into messaging, design, and all other avenues where the inclusion of this powerful neurological phenomenon can be applied. In particular embodiments, neuro-iconic signatures may represent one of the core ‘connective tissues’ that link different executions across different channels to allow for maximum neurological coherence and marketplace effectiveness.

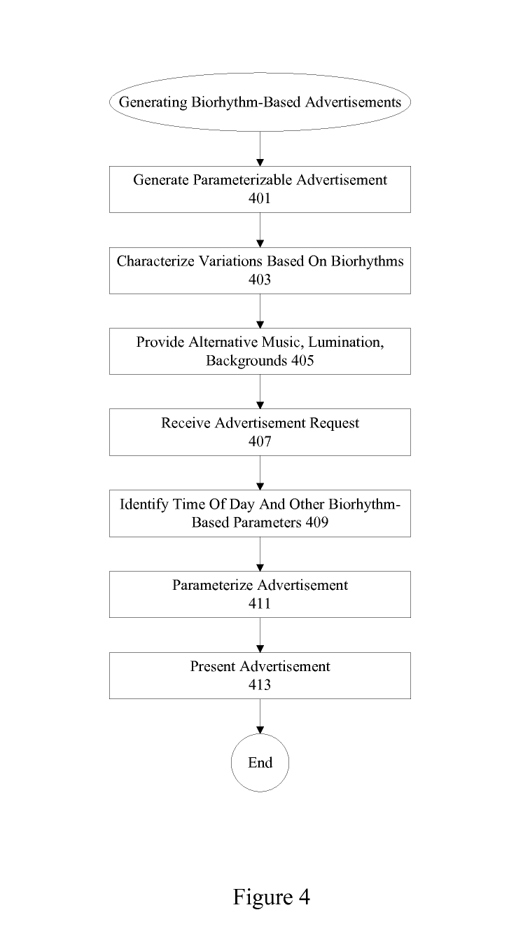

FIG. 4 illustrates a particular example of a mechanism for biorhythm-based advertisement creation. According to various embodiments, biorhythm-based advertisement variants are created to correspond with natural neurological biorhythms. It is recognized that the brain is fundamentally and universally driven by specific biological mechanisms. Two of the most critical are the brain/body's reliance on a 24-hour ‘biological clock’, and on a broader basis, perceived changes in the overall environment, such as light and temperature among others. By leveraging these natural rhythms and responses into strategies and creative executions, the advertisement creation mechanism will create uniquely compelling commercial messaging for clients.

In the present exemplary embodiment, a parameterizable advertisement is generated at 401. In particular, certain aspects of the advertisement can be selected to stay constant across various versions, and other aspects of the advertisement can be selected to be variable (i.e. interchangeable with other options). For the parts of the advertisement that are anchored across various versions, neuro-compression can be applied in some embodiments such that important aspects of the advertisement are retained in the compressed version. In addition, neuro-iconic signatures can be embedded in the anchored content of the advertisement, according to various embodiments. In one example, the anchored parts of an advertisement may be characters, words, people, etc. in the foreground and the variable parts of the advertisement may be the background, lighting, music, colors, etc. The variable parts could be changed in alternate versions of an advertisement.

In the present exemplary embodiment, variations of the advertisement are characterized based on biorhythms at 403. For instance, minor parameter based variations can be introduced into an advertisement that can be automatically switched based on time of day. In some examples, illumination, music, and objects within an advertisement may change based on time of day. For instance, a background image may automatically change to a scene corresponding to the current position of the sun.

At 405, alternative music, lumination, and background are provided. In particular, music accompanying an ad may be changed depending on the time of day Alternative musical tracks may be provided for morning, mid-day/afternoon, evening, late night, etc. These musical tracks can be selected to compliment the mood and feelings associated with these times of day. Lumination alternatives may include the brightness and hue of the advertisement. For example, bright sunny yellows and blues can be used for advertisements shown in the mid-day, while sunset hues of oranges and reds can be used in advertisements shown at dusk. Furthermore, the direction and harshness of shadows, etc. can be altered to reflect the time of day. Accordingly, alternative variations based on lumination can be provided. Background alternatives may include different settings associated with the time of day, such as a kitchen table in the morning, a park or office setting in the day, and a bedroom for late night. If more subtle variations are desired, the backgrounds can remain the same or similar across versions of an advertisement, such as a room with a window, but lighting as seen through the window can be altered. For instance, the lighting through the window can be changed depending on time of day. Alternative variations for backgrounds can be provided for various times of day associated with the advertisement.

In the present exemplary embodiment, an advertisement request is received at 407. This request can be made by a device providing content to a viewer, by a viewer of content, a device displaying various advertisements (i.e. a mall advertisement), etc. Once the advertisement request is received, the time of day and other biorhythm-based parameters can be determined at 409. In some embodiments, these parameters can be determined based on the actual time of day and the date, and can account for seasonal changes in daylight, sunrise, sunset, etc. Furthermore, in some embodiments, seasonal changes can determine the type and amount of light that corresponds to the local conditions.

Next, at 411, the advertisement is parameterized. For example, if the time of day is determined to be dusk, the advertisement can be parameterized to include musical, lumination, and background selections that correspond to dusk. Finally, the parameterized advertisement is presented at 413.

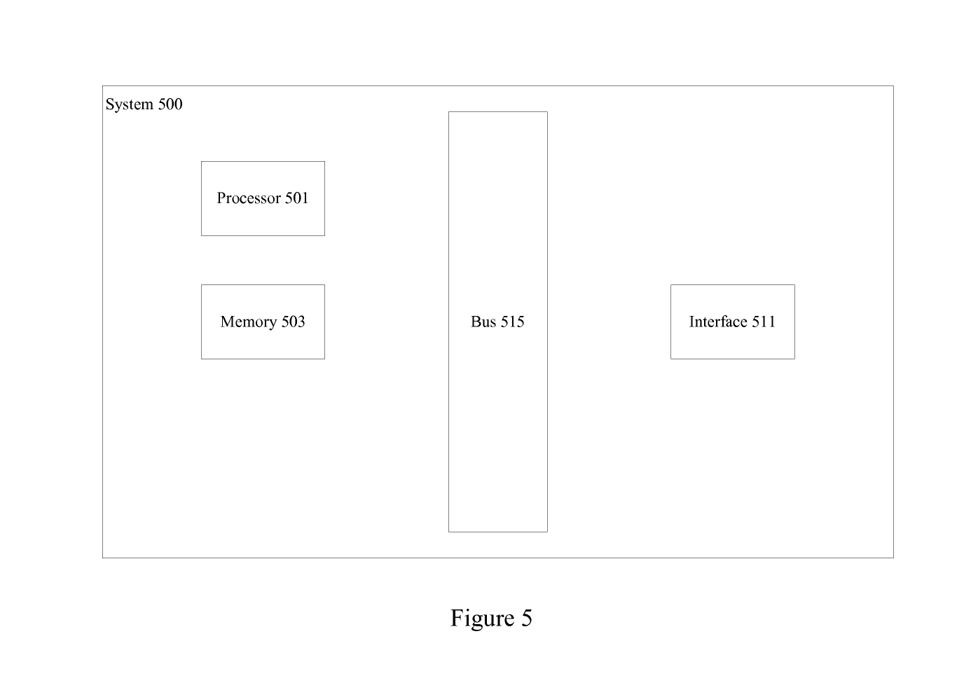

FIG. 5 illustrates a particular example of a server that can be used to implement particular examples of the present invention. For instance, the server can be used to generate, select, and/or display advertisements according to various embodiments described above. According to particular example embodiments, a system 500 suitable for implementing particular embodiments of the present invention includes a processor 501, a memory 503, an interface 511, and a bus 515 (e.g., a PCI bus). The interface 511 may include separate input and output interfaces, or may be a unified interface supporting both operations. When acting under the control of appropriate software or firmware, the processor 501 is responsible for such tasks such as optimization. Various specially configured devices can also be used in place of a processor 501 or in addition to processor 501. The complete implementation can also be done in custom hardware. The interface 511 is typically configured to send and receive data packets or data segments over a network. Particular examples of interfaces the device supports include Ethernet interfaces, frame relay interfaces, cable interfaces, DSL interfaces, token ring interfaces, and the like.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 500 uses memory 503 to store data and program instructions and maintained a local side cache. The program instructions may control the operation of an operating system and/or one or more applications, for example. The memory or memories may also be configured to store received metadata and batch requested metadata.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method comprising:
receiving a request to maintain a first plurality of emotion-based versions of a first advertisement, wherein the first plurality of emotion-based versions include the same messaging;
identifying a current emotion-based state associated with a viewer by analyzing camera data from a device used by the viewer;
selecting one of the first plurality of emotion-based versions of the first advertisement from a database by using a processor, wherein one of the first plurality of emotion-based versions of the first advertisement is selected based on the current emotion-based characteristics associated with the viewer;
identifying a resulting emotion-based state associated with the viewer by analyzing camera data from the device used by the viewer to detect a change in emotion-based state; and
selecting one of a second plurality of emotion-based versions of a second advertisement from the database by using the processor, wherein one of the second plurality of emotion-based versions of the second advertisement is selected based on the resulting emotion-based characteristics associated with the viewer.

2. The method of claim 1, wherein one of the first plurality of emotion-based versions of the first advertisement is parameterized using biorhythm-based characteristics associated with the viewer.

3. The method of claim 2, wherein biorhythm-based characteristics include time of day.

4. The method of claim 3, wherein one of the first plurality of emotion-based versions of the first advertisement is parameterized by varying biorhythm-based parameters of the first advertisement.

5. The method of claim 4, wherein biorhythm parameters include background music and illumination.

6. The method of claim 4, wherein biorhythm parameters include background scenery and illumination.

7. The method of claim 1, wherein one of the first plurality of emotion-based versions of the first advertisement is presented to the viewer using a display.

8. The method of claim 1, wherein the first plurality of advertisements are optimized for particular contexts including screen size and resolution by focusing on attention for smaller screens and lower resolutions and focusing on valence for larger screens and higher resolutions.

9. The method of claim 1, wherein the advertisement further comprises media asset wrapper connectivity to blend the advertisement into surrounding content.

10. A system comprising:
an interface configured to receive a request to maintain a first plurality of emotion-based versions of a first advertisement, wherein the first plurality of emotion-based versions include the same messaging;
a processor configured to identify a current emotion-based state associated with a viewer by analyzing camera data from a device used by the viewer and select one of the first plurality of emotion-based versions of the first advertisement from a database by using a processor, wherein one of the first plurality of emotion-based versions of the first advertisement is selected based on the current emotion-based characteristics associated with the viewer;
wherein the processor is further configured to identify a resulting emotion-based state associated with the viewer by analyzing camera data from the device used by the viewer to detect a change in emotion-based state and select one of a second plurality of emotion-based versions of a second advertisement from the database by using the processor, wherein one of the second plurality of emotion-based versions of the second advertisement is selected based on the resulting emotion-based characteristics associated with the viewer.

11. The system of claim 10, wherein one of the first plurality of emotion-based versions of the first advertisement is parameterized using biorhythm-based characteristics associated with the viewer.

12. The system of claim 11, wherein biorhythm-based characteristics include time of day.

13. The system of claim 12, wherein one of the first plurality of emotion-based versions of the first advertisement is parameterized by varying biorhythm-based parameters of the first advertisement.

14. The system of claim 13, wherein biorhythm parameters include background music and illumination.

15. The system of claim 13, wherein biorhythm parameters include background scenery and illumination.

16. The system of claim 10, wherein one of the first plurality of emotion-based versions of the first advertisement is presented to the viewer using a display.

17. The system of claim 10, wherein the first plurality of advertisements are optimized for particular contexts including screen size and resolution by focusing on attention for smaller screens and lower resolutions and focusing on valence for larger screens and higher resolutions.

18. The system of claim 10, wherein the advertisement further comprises media asset wrapper connectivity to blend the advertisement into surrounding content.

19. A non-transitory computer readable medium comprising:
computer code for receiving a request to maintain a first plurality of emotion-based versions of a first advertisement, wherein the first plurality of emotion-based versions include the same messaging;
computer code for identifying a current emotion-based state associated with a viewer by analyzing camera data from a device used by the viewer;
computer code for selecting one of the first plurality of emotion-based versions of the first advertisement from a database by using a processor, wherein one of the first plurality of emotion-based versions of the first advertisement is selected based on the current emotion-based characteristics associated with the viewer;
computer code for identifying a resulting emotion-based state associated with the viewer by analyzing camera data from the device used by the viewer to detect a change in emotion-based state; and
computer code for selecting one of a second plurality of emotion-based versions of a second advertisement from the database by using the processor, wherein one of the second plurality of emotion-based versions of the second advertisement is selected based on the resulting emotion-based characteristics associated with the viewer.

20. The non-transitory computer readable medium of claim 1, wherein one of the first plurality of emotion-based versions of the first advertisement is parameterized using biorhythm-based characteristics associated with the viewer.
